(19) United States
(12) Patent Application Publication
(10) Pub. No.: US 2010/0090856 A1
(43) Pub. Date: Apr. 15, 2010

(54) Emergency alarming apparatus

(76) Inventor: Juei-Chao Chen, Taipei City (TW)

Correspondence Address: Juei-Chao, CHEN, P.O. BOX 46-563, Taipei, Taipei City, 10499, TW

(21) Appl. No.: 12/287,436

(22) Filed: Oct. 10, 2008

(51) Int. Cl. G08B 7/00; H04M 11/04

(52) U.S. Cl. 340/691.6; 379/40

(57) ABSTRACT

An emergency alarming apparatus primarily comprises one or more sensing modules, a control module and one or more display unit. Upon sensing a fire or an emergency, the sensing module sends a signal to the control module, and then the control module sends a control signal to the display units disposed in all floors or areas in a building to display a category to which the fire or emergency belongs and the floor or area where the fire or emergency is taking place on the display units, thus accomplishing the alarming and guiding purpose.

### BACKGROUND OF THE INVENTION

1. Technical Field

The present invention relates to an emergency alarming apparatus, and more particularly, to an apparatus that gives an alarm by indicating a floor or an area where a fire or an emergency is taking place on a display unit in response to detection of the fire or emergency by a sensing module.

2. Description of Related Art

Nowadays, more and more buildings are springing up to accommodate rapidly increasing population. In order to provide more available space, the buildings are also constructed at an ever-increasing height. Besides earthquakes and other natural disasters, fires break out from time to time especially in metropolitans or other areas with the densest population. Therefore, to minimize casualties caused by the fires, fire prevention and control become very important for the buildings. Fire alarm systems in general buildings operate in the following way. When a smoke sensor or a temperature sensor senses breaking out of a fire, a fire alarm signal is sent to a control panel, which then triggers an alarm bell for alarm purpose. Another kind is the passive alarming systems, in which when a fire breaks out, a person may press the fire-alarm system to trigger subsequent actions of the alarm bells in the corresponding region. However, in case of a fire, the normal response of average people is to move towards emergency exits in an attempt to flee from the involved building or area. However, while serving to alarm that a fire has broken out in the building or area, the alarm bells are unable to guide or direct fleeing people to move towards the emergency route or direction; in many cases, the fleeing people may even move towards the floor and area where the fire is taking place due to the chaos and poor sight conditions, thereby causing unnecessary casualties. Therefore, a need still remains for improvement of such fire-alarm systems.

Accordingly, how to obviate the above problem is still a technical challenge to be addressed by the present inventor.

### BRIEF SUMMARY OF THE INVENTION

In view of the shortcomings described above and by collecting relevant data and making an evaluation and consideration on all aspects of this problem, the present inventor has made repeated experiments and modifications based on years of experience in the art, and finally works out this invention that displays a category to which a fire or an emergency belongs and a floor or an area where the fire or emergency is taking place on a display unit in response to detection of the fire or emergency by a sensing module.

The primary objective of this invention is that, the emergency alarming apparatus primarily comprises one or more sensing modules, a control module and one or more display units wherein the sensing modules are disposed in different areas of different floors to sense conditions within respective areas and the display units are disposed at emergency exits, emergency routes or other visible locations. With this arrangement, in case a fire or an emergency takes place, the adjacent sensing modules tell a category to which the fire or emergency belongs and a site, such as a floor or an area, where the fire or emergency is taking place, and transmits a corresponding signal to the control module. Then the control module transmits a control signal to all of the display units in every floor or area so that the category to which the fire or emergency belongs and the site where the fire or emergency is taking place can be displayed in forms of numerals, characters or symbols, thus accomplishing the alarming purpose.

A secondary objective of this invention is that, the control module may be further connected with a communication module. Upon receiving the signal transmitted from the sensing modules, the control module sends a control signal also to the communication module so that the communication module automatically dials at least one group of predetermined telephone numbers of personal cell phones or telephones or other communication facilities for fire-alarm or emergency-alarm purpose.

Another objective of this invention is that the sensing modules can be numbered according to the predetermined areas. Then in case a fire or an emergency takes place, in addition to the floor where the fire or emergency is taking place, the serial number of the area as well as the emergency category in forms of patterns or symbols can also be displayed on the display unit so that the fleeing people will be informed more exactly of where the fire or emergency is taking place and take appropriate measures.

### BRIEF DESCRIPTION OF THE SEVERAL VIEWS OF THE DRAWINGS

The present invention as well as a preferred mode of use and advantages thereof will be best understood by referring to the following detailed description of an illustrative embodiment in conjunction with the accompanying drawings, wherein:

FIG. 1 is a perspective outline view of the present invention;

FIG. 2 is a first view of the preferred embodiment of the present invention;

FIG. 3 is a second view of the preferred embodiment of the present invention;

FIG. 4 is a third view of the preferred embodiment of the present invention;

FIG. 5 is a fourth view of the preferred embodiment of the present invention;

FIG. 6 is a first view of a further embodiment of this invention;

FIG. 7 is a second view of the further embodiment of this invention; and

FIG. 8 is a third view of the further embodiment of this invention.

### DETAILED DESCRIPTION OF THE INVENTION

Hereinafter, the technical means and structure employed by this invention to accomplish the above objectives and functionalities will be described in detail with reference to preferred embodiments of this invention to facilitate a thorough understanding.

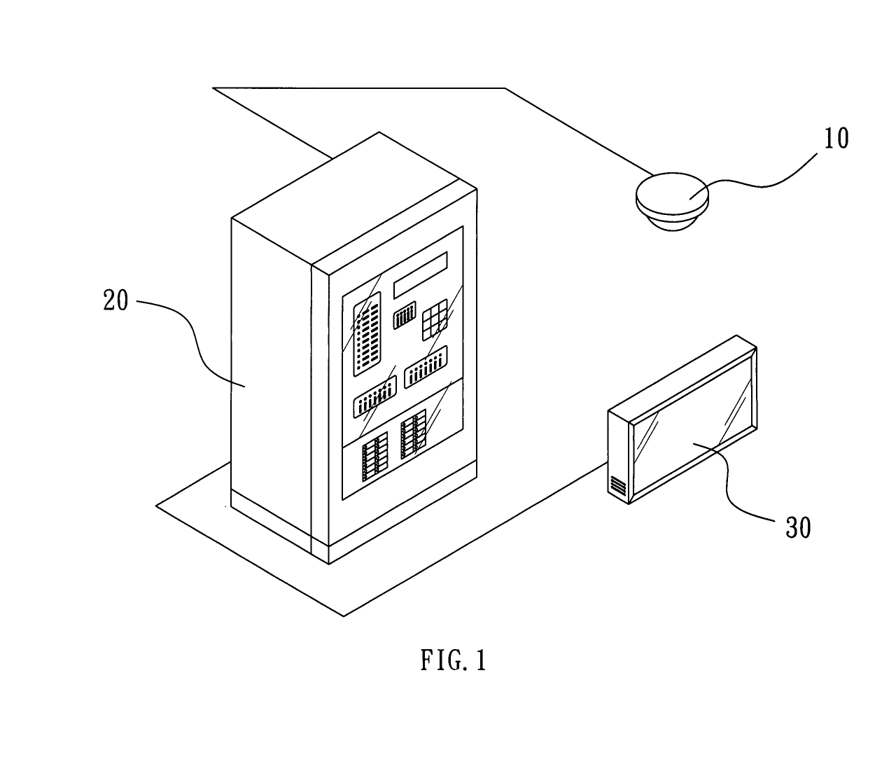

Referring to FIG. 1, a perspective outline view of the present invention is shown therein. As can be seen clearly from this figure, the emergency alarming apparatus primarily comprises at least one sensing module 10, a control module 20 and at least one display unit 30. The sensing module 10 and the display unit 30 may be provided in plural and disposed in every floor or in designated areas of a building. The sensing module 10 is provided with at least one of a temperature sensor, a smoke sensor and a gas sensor therein. The display unit 30 displays information in forms of numerals, characters or symbols. The emergency alarming apparatus operates primarily in the following way. By sensing a category to which a fire or an emergency belongs and a floor or an area where the fire or emergency is taking place, the sensing module 10 sends a signal to the control module 20 which then controls the display unit 30 to display the floor or area where the fire or emergency is taking place. Thus, in case a fire or an emergency takes place, information displayed by the display unit 30 will guide people to keep away or flee away from the involved floor or area, thus accomplishing the alarm purpose.

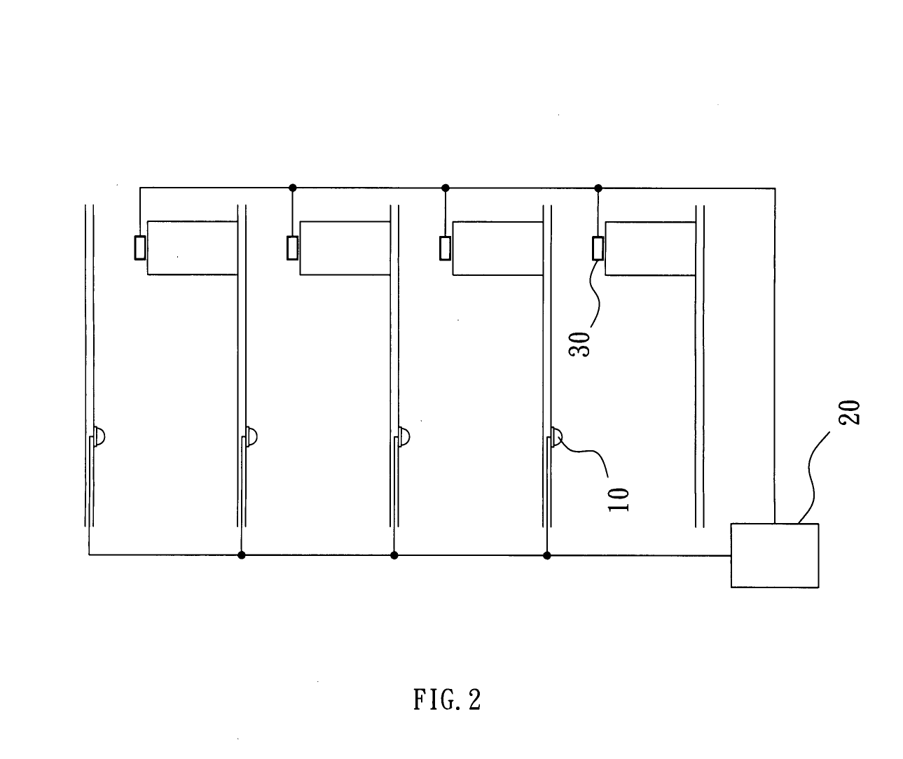

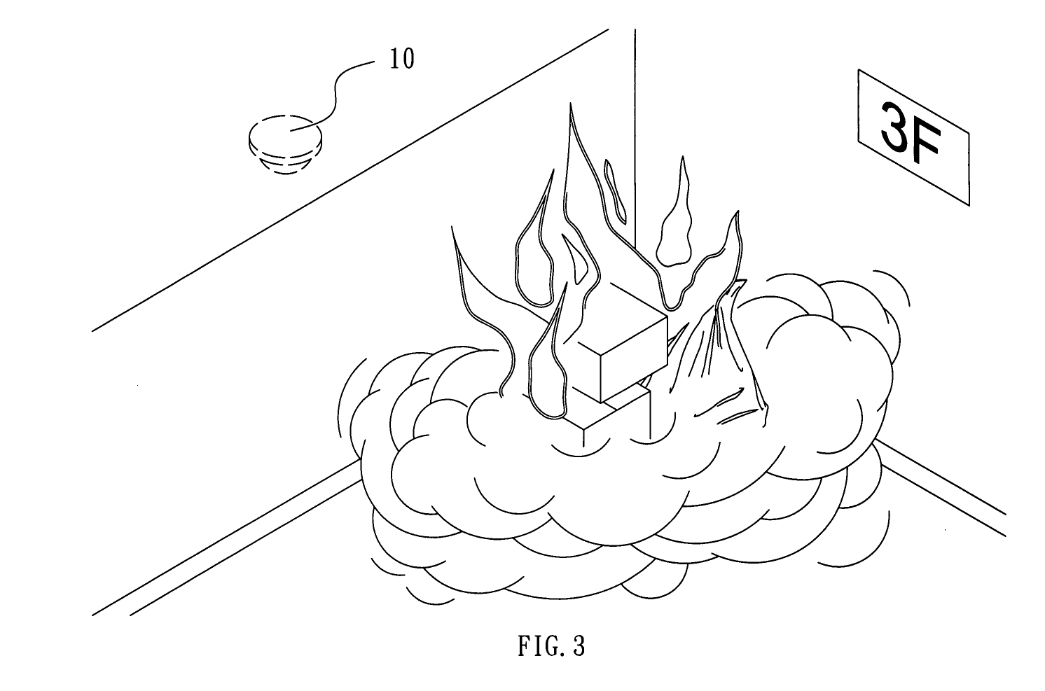

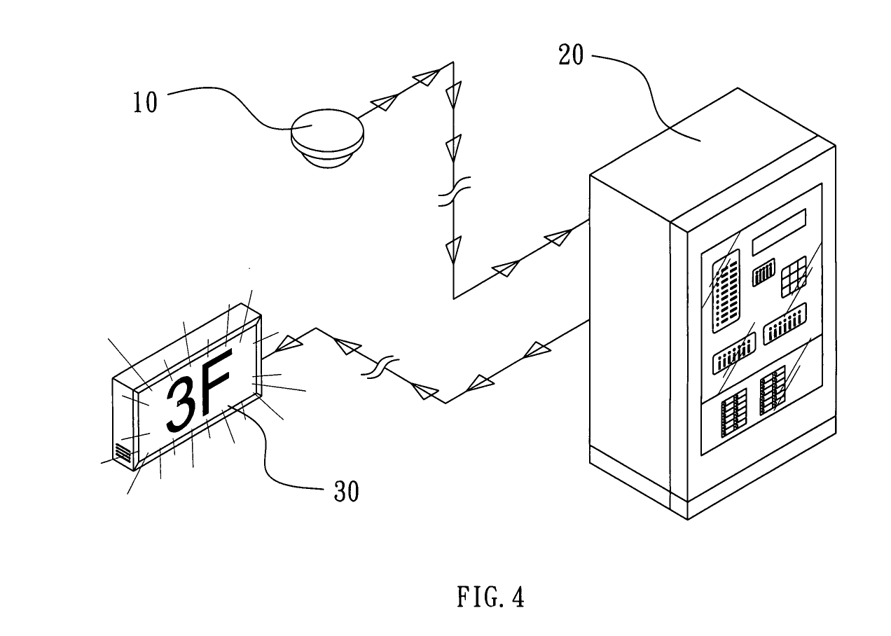

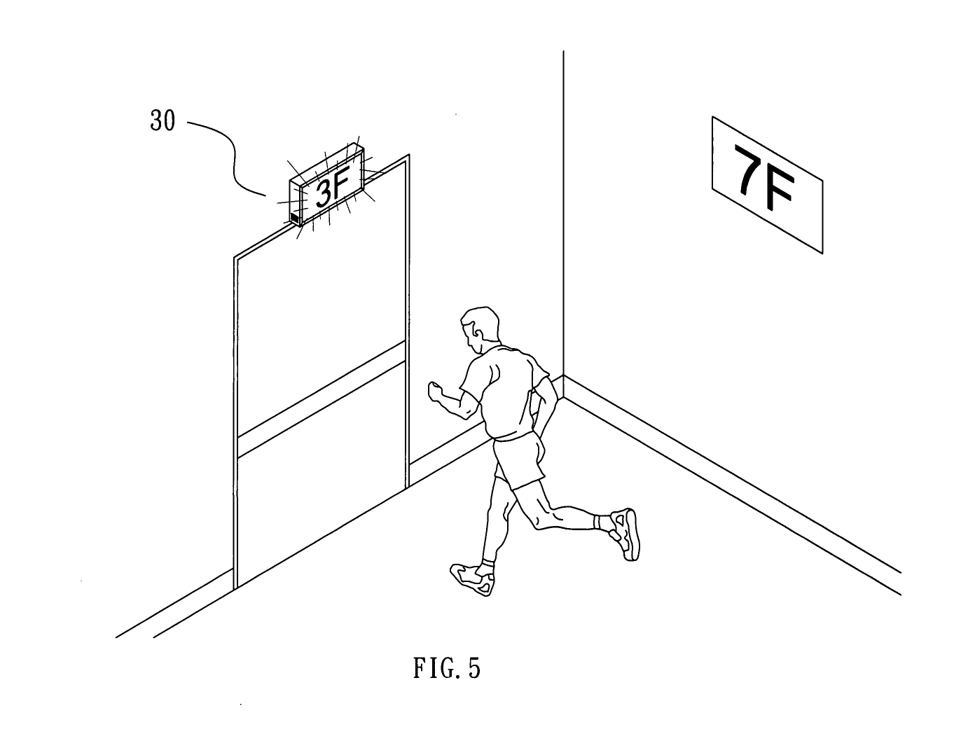

Referring to FIGS. 2, 3, 4 and 5 (together with FIG. 1), a preferred embodiment of the present invention is shown therein. As can be seen clearly from these figures, plural said sensing modules 10 are disposed in every floor or area in a building to sense occurrence of a fire or an emergency within the range while plural said display units 30 are disposed in the emergency route or at the emergency exits or other visible locations. In case a fire or an emergency takes place, an abnormal temperature, smoke concentration or abnormal level of carbon monoxide or gases in the air will be sensed by a temperature sensor, a smoke sensor or a gas sensor in the adjacent sensing module 10. In response to this, the sensor transmits a signal to the control module 20 to inform it of the floor or area where the fire or emergency is taking place. Then the control module 20 transmits a control signal to the display units 30 disposed in all floors to display the number of the floor in fire on the display units 30 in forms of numerals or characters. In this way, the fleeing people in the whole building can be informed of the floor or area currently in fire through the information displayed on the display units 30. More specifically, for fleeing people on the floor in fire, they can get away from this floor immediately; and for those on other floors, they can keep away from rather than move towards the floor or area in fire in panic, thus avoiding unnecessary casualties.

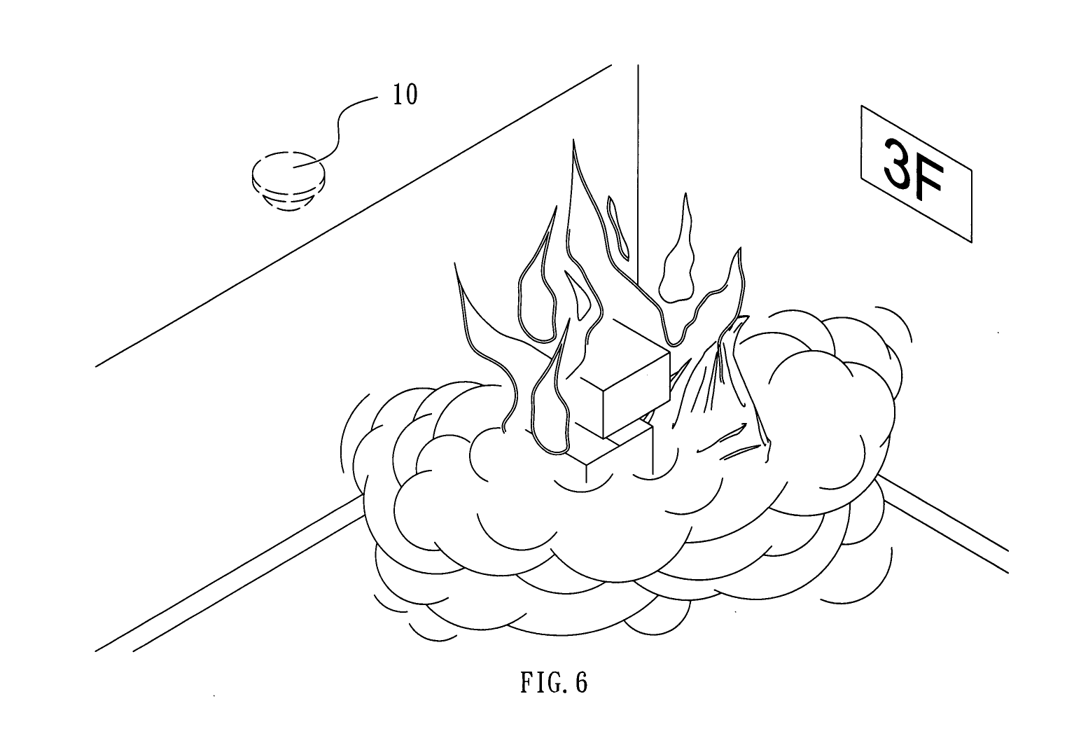

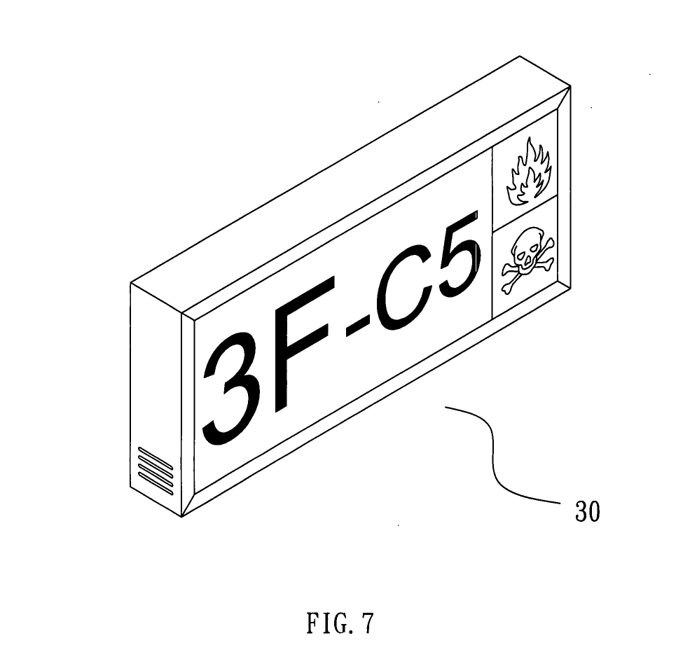

Referring to FIGS. 6 and 7, a further embodiment of the present invention is shown therein. As can be seen clearly from these figures, the sensing modules 10 disposed in every floor can be numbered according to respective areas. Then in case a fire or an emergency takes place, in addition to the floor where the fire or emergency is taking place, the serial number of the area in forms of numerals or characters as well as the emergency category in forms of patterns or symbols can be displayed on each said display unit 30. Thus, the fleeing people will be informed more exactly of where the fire or emergency is taking place and what category it is, and keep away from this floor or area or take appropriate measures.

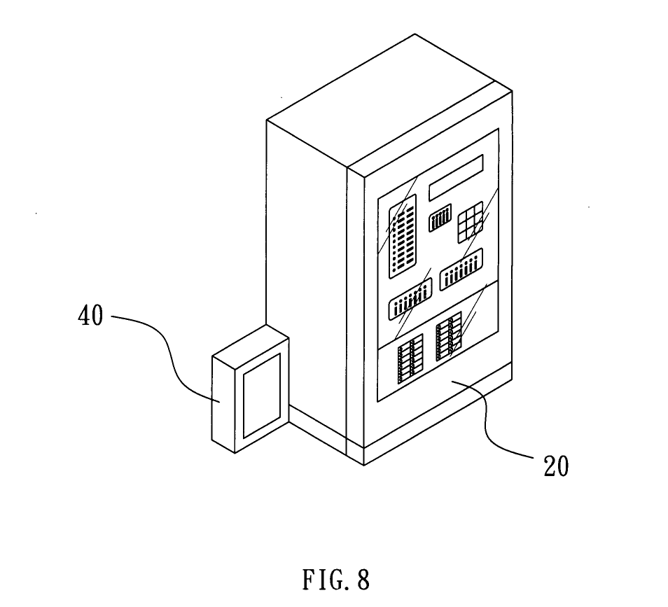

Referring to FIG. 8 (together with FIG. 2), a further embodiment of the present invention is shown therein. As can be seen clearly from this figure, the control module 20 may be further connected with a communication module 40. In case a fire or an emergency takes place, an abnormal temperature, smoke concentration or abnormal level of carbon monoxide or gases in the air will be sensed by the sensing module 10. In response to this, the sensing module 10 transmits a signal to the control module 20 to inform it of the floor or area where the fire or emergency is taking place as well as the category of the fire or emergency. Then the control module 20 transmits a control signal to the display unit 30 disposed in every floor or area to display the serial number of the floor in fire or emergency on the display unit 30. Meanwhile, the control module 20 also sends a signal to the communication module 40 so that the communication module 40 automatically dials at least one predetermined telephone number of a personal cell phone or a telephone or a communication facility located within or outside the building or area for fire-alarm or emergency-alarm purpose. Additionally, the communication module 40 may further send an audio signal to elevators, every floor or every designated area to give an alarm message through broadcast.

1. An emergency alarming apparatus, primarily comprising:
one or more display units, disposed at emergency exits or emergency routes of different floors or areas in a building to indicate one said floor or area where a fire or an emergency is taking placing as well as a category of the fire or emergency;
one or more sensing modules, disposed in the different floors or areas in the building;
a control module, configured to receive a sensing signal from the sensing modules and control the display units accordingly;
wherein when one said sensing module disposed in one said floor or area where the fire or emergency is taking placing sends the sensing signal to the control module, the control module receives the sensing signal and sends a control signal to the display units in all the floors or areas so that the display units indicate thereon the floor or area where the fire or emergency is taking place and the category to which the fire or emergency belongs.

2. The emergency alarming apparatus of claim 1, further comprising a communication module, wherein in case a fire or an emergency takes place, the control module sends a fire or emergency signal to the communication module so that the communication module automatically dials at least one group of predetermined telephone numbers of personal cell phones or telephones or other communication facilities to give a fire-alarm or emergency-alarm message.

3. The emergency alarming apparatus of claim 1, wherein the display unit indicates the floor or area where the fire or emergency is taking place in forms of numerals or characters.

4. The emergency alarming apparatus of claim 1, wherein the display unit indicates the category of the emergency in forms of patterns.

5. The emergency alarming apparatus of claim 1, wherein at least one of a temperature sensor, a smoke sensor and a gas sensor is provided in each of the sensing modules.

6. The emergency alarming apparatus of claim 1, wherein the sensing modules disposed in different floors or areas are numbered according to the floors or areas they are disposed, so that when a fire or an emergency takes place, a coded number, a code or a category of the sensing module corresponding to the fire or emergency is displayed on the display units.

7. The emergency alarming apparatus of claim 5, wherein the communication module further sends an audio signal to every elevator, every floor or every designated area in the building to give an alarm message through broadcast.
